(19) United States
(12) Patent Application Publication
(10) Pub. No.: US 2018/0139667 A1
(43) Pub. Date: May 17, 2018

(54) MINIMIZATION OF SERVICE INTERRUPTION DURING RELAY RESELECTION IN DEVICE-TO-DEVICE (D2D) BASED USER EQUIPMENT (UE)-TO-NETWORK RELAY

(71) Applicant: Nokia Technologies Oy, Espoo (FI)

(72) Inventors: Ling YU, Kauniainen (FI); Vinh VAN PHAN, Oulu (FI); Manivannan THYAGARAJAN, Coppell, TX (US)

(21) Appl. No.: 15/573,338

(22) PCT Filed: May 25, 2016
(86) PCT No.: PCT/IB2016/053070

§ 371 Date: Nov. 10, 2017

Related U.S. Application Data
(60) Provisional application No. 62/168,347, filed on May 29, 2015.

(51) Int. Cl. H04W 36/02; H04W 4/02; H04W 8/00; H04W 88/04; H04W 76/23

(52) U.S. Cl. CPC H04W 36/023; H04W 4/02; H04W 76/23; H04W 88/04; H04W 8/005

(57) ABSTRACT

Systems, methods, apparatuses, and computer program products for minimizing service interruption during relay reselection in D2D based UE-to-network relay are provided.

### BACKGROUND

### Field

Certain embodiments generally relate to communication systems, and for example, to device-to-device (D2D) communication integrated into a communications network, such as, but not limited to, long-term evolution (LTE) or long-term evolution advanced (LTE-A) cellular network specified by the 3rd Generation Partnership Project (3GPP).

### Description of the Related Art

Two types of communication networks include cellular networks and ad-hoc networks. A cellular network is a radio network made up of one or more cells, where each cell is served by at least one centralized controller, such as a base station (BS), a Node B, or an evolved Node B (eNB). In a cellular network, a user equipment (UE) communicates with another UE via the centralized controller, where the centralized controller relays messages sent by a first UE to a second UE, and viceversa. In contrast, in an ad-hoc network, a UE directly communicates with another UE, without the need of a centralized controller. Utilizing a cellular network versus an ad-hoc network has its benefits and drawbacks. For example, utilizing a cellular network over an ad-hoc network provides the benefit of easy physical resource control and interference control. However, utilizing a cellular network over an ad-hoc network also provides the drawback of inefficient physical resource utilization. For instance, additional physical resources may be required in a cellular network when the two UEs are close to each other, as compared to an ad-hoc network.

A hybrid network utilizes both a cellular mode and a device-to-device (D2D) transmission mode. In a hybrid network, a UE may choose to communicate either via a cellular mode or a D2D transmission mode. As an example, a hybrid network may allow UEs to communicate either via a cellular mode (i.e. via a centralized controller) or via a D2D transmission mode where the UEs may establish a direct channel which may or may not be under the control of a centralized controller. The UE and/or its controlling network may make this selection depending on which mode provides better overall performance. Thus, a hybrid network may improve total system performance over a cellular network or an ad-hoc network. However, in order to utilize a hybrid network, issues related to physical resource sharing and interference situations may need to be addressed.

In addition, proximity services (ProSe)/D2D discovery and communication is one of the ongoing work items for 3GPP Release 13 and beyond. D2D scenarios that are currently being studied in 3GPP include D2D in network coverage, out of network coverage, and partial network coverage scenarios.

### BRIEF DESCRIPTION OF THE DRAWINGS

For proper understanding of the invention, reference should be made to the accompanying drawings, wherein:

FIG. 1 illustrates an example signaling diagram according to one embodiment;

FIG. 2a illustrates a block diagram of an apparatus according to an embodiment;

FIG. 2b illustrates a block diagram of an apparatus according to another embodiment;

FIG. 3a illustrates a flow diagram of a method according to one embodiment; and

FIG. 3b illustrates a flow diagram of a method according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of systems, methods, apparatuses, and computer program products for minimizing service interruption during relay reselection in D2D based UE-to-network relay, as represented in the attached figures, is not intended to limit the scope of the invention, but is merely representative of selected embodiments of the invention.

The features, structures, or characteristics of the invention described throughout this specification may be combined in any suitable manner in one or more embodiments. For example, the usage of the phrases “certain embodiments,” “some embodiments,” or other similar language, throughout this specification refers to the fact that a particular feature, structure, or characteristic described in connection with the embodiment may be included in at least one embodiment of the present invention.

Thus, appearances of the phrases “in certain embodiments,” “in some embodiments,” “in other embodiments,” or other similar language, throughout this specification do not necessarily all refer to the same group of embodiments, and the described features, structures, or characteristics may be combined in any suitable manner in one or more embodiments. Additionally, if desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

Some embodiments of the invention are applicable to LTE-Advanced, including 3GPP LTE-A Rel-12, Rel-13, and beyond, which addresses LTE-Advanced support for D2D discovery and communication without limitation to LTE-Advanced. The 3GPP has begun carrying out a study for potential services and requirements for D2D communications, referred to as Proximity Services (ProSe). One objective of this study is to look at use cases and identify potential requirements for an operator network controlled discovery and communications between devices that are in proximity, under continuous network control, and/or are under 3GPP network coverage. This could be for the purposes of commercial/social use, network offloading, public safety, and/or integration of current infrastructure services to assure the consistency of the user experience including reachability and mobility aspects.

3GPP Release 13 working item for ProSe enhancement includes an objective of defining enhancements to D2D communication to enable the following features: support the extension of network coverage using layer 3 based UE-to-Network Relays, including service continuity (if needed), based on Release 12 D2D communication, considering applicability to voice and/or video.

The following agreements on ProSe UE-to-Network relay have been made by 3GPP (at RAN2 #89bis meeting):
For the relay discovery and relay selection, both in-coverage and out-of-coverage scenarios for remote UEs can be addressed.
Discuss the potential minimization of service interruption for the cases where the UE is moving from in-coverage to out-of-coverage and from out-of-coverage to in-coverage.
The remote UE can take radio level measurements of the PC5 radio link quality.
For out-of-coverage, the radio level measurements can be used by the remote UE together with other higher layer criteria to perform relay selection.
For in-coverage, it is for further study how these measurements are used (e.g., the measurements can be used by the UE to perform selection similar to out-of-coverage case, or they can be reported to the eNB).
It is for further study how reselection is handled and who performs reselection decision. Also for further study if Uu link quality is required for selection/reselection purposes.

From these agreements, it can be seen that the service interruption/continuity issue will be considered for UE-to-Network relay. Even though only the cases where UE is moving from in-coverage to out-of-coverage or vice-versa has been mentioned, the case where relay UE is reselected due to mobility of either remote UE or relay UE should be taken into account as well for minimization of service interruption. During relay UE reselection, the data packet loss may happen, for example, if DL data targeted to remote UE has already been transmitted to the eNB or even transmitted to the old relay UE, but the eNB or old relay UE has not yet forwarded the data to the remote UE before the remote UE reselects another relay UE. Also, the data packet loss in uplink (UL) direction may happen during relay UE reselection if the old serving relay UE cannot receive D2D packet from the remote UE reliably enough before a new serving relay UE is selected.

According to certain embodiments of the invention, the following assumptions may be made. For example, Layer-3 based UE-to-Network (UE2NW) relay may be transparent to eNB. Therefore, eNB assisted service interruption/continuity (e.g., eNB is aware of old and new serving relay UEs of the remote UE and takes care of the service interruption/continuity by radio bearer mapping or data forwarding via cellular links and/or X2 interface) cannot be applied. Though SA2 has agreed to have a secure Layer-2 link establishment over PC5 for UE2NW relay, explicit signaling on Access Stratum level for One-to-One communication between relay and remote UE may not be needed if it is based on 3GPP Release 12 1-to-many (1:M) D2D communication, in which the relay ProSe UE ID and remote ProSe UE ID identified via ProSe UE-to-Network Relay discovery is used as Destination Layer-2 ID in 1:M communication.

Embodiments of the invention, which aim to minimize the service interruption during relay UE reselection, provide an UE assisted service interruption minimization solution and corresponding signalling and data forwarding mechanism for D2D based UE-to-Network relay.

In one embodiment, information about the serving relay UE (e.g., ProSe relay UE ID) may be advertised by the remote UE in a ProSe UE-to-Network Relay discovery message so that the candidate relay UEs may check if the current serving relay UE is in D2D communication range and, if so, provide this information to the remote UE to assist in relay UE reselection. For instance, when a remote UE wants to discover relay UEs for relay UE reselection, the remote UE may indicate the serving relay UE information, such as the ProSe relay UE ID, in the ProSe UE-to-Network Relay discovery request message. In response, the candidate relay UEs may reply with an indication if it is in D2D communication range or not with the serving relay UE.

In another embodiment, a Service Interruption Minimization Indication (SIMI) may be provided by the remote UE to the candidate relay UEs during relay UE discovery or during one-to-one communication (using 1:M based D2D communication solution) between remote UE and new serving relay UE. The SIMI may indicate that some or all of the services of the remote UE need service continuity support. Thus, the SIMI may be provided at the user group, user service, UE or logical channel level and may depend on the user group/service/UE/logical channel QoS/priority.

According to an embodiment, to minimize the DL service interruption/packet loss, the SIMI may be provided by the remote UE either in a relay UE discovery message or the first D2D communication message for one-to-one communication (for example using 1:M based D2D communication solution as specified in 3GPP release 12) to the new serving relay UE. In addition to SIMI, the received packet data convergence protocol (PDCP)/radio link control (RLC) sequence number (SN) information may be provided from the remote UE to the new serving relay UE in order to assist packet loss recovery in a more efficient manner.

Upon receiving the SIMI and optional PDCP/RLC SN in the relay UE discovery message, the candidate relay UEs may start monitoring, receiving and buffering the D2D communication targeted to the remote UE from the serving relay UE. The selected new serving relay UE may then forward the buffered and also newly received ProSe communication data to the remote UE after the first D2D communication message from the remote UE is received by the new serving relay UE. The other candidate relay UEs may delete the buffered data if ProSe communication message from the remote UE is not received within a certain time period at the candidate relay UEs. In case of SIMI and optional PDCP/RLC SN provided in the first ProSe communication message from the remote UE to the new serving relay UE, the new serving relay UE may start monitoring, receiving and forwarding the D2D communication targeted to the remote UE from the old serving relay UE.

To minimize the UL service interruption, the SIMI may be provided by the remote UE in the relay UE discovery message. Thus, the candidate relay UEs, upon receiving SIMI, may start monitoring, receiving and buffering the D2D communication data from the remote UE targeted to the serving relay UE. When the remote UE sets up one-to-one communication connection using 1:M based D2D communication solution with new serving relay UE, the new serving relay UE may forward the buffered data either via its own cellular connection or via the old serving relay UE's cellular connection to the network. For the latter, the data forwarding from the new serving relay UE to old serving relay UE may take into account the received data in the old serving relay UE, for example, based on PDCP/RLC SN of each logical channel.

In another embodiment, the serving relay UE may send a resource release indication (RRI) targeted to the remote UE in a ProSe discovery/communication message. The remote UE, upon receiving RRI, will release resources used locally in the remote UE. If RRI is provided in a ProSe discovery message, the remote UE ID may be indicated in the RRI related message. The new serving relay UE, upon receiving it, may forward it to remote UE via one-to-one communication link between the new serving relay UE and remote UE. If RRI is provided in ProSe communication message which is targeted to the remote UE, the new serving relay UE may forward the information to the remote UE if service interruption minimization is activated by the remote UE as discussed above.

For the downlink (DL) direction, RRI may be triggered by the empty buffer in the serving relay UE for data targeted to the remote UE. Thus, RRI can be in the form of Last-Packet-Indication (LPI) sent to the remote UE. Upon receiving the RRI/LPI either directly from the serving relay UE or forwarded by the new serving relay UE, the remote UE may release resources (e.g., buffers of the logical channels established locally in remote UE) for the link with the indicated serving relay UE.

For the UL direction, RRI may be triggered by the inactivity detection at the serving relay UE. For instance, when serving relay UE doesn't receive any ProSe communication from the remote UE for certain time period, the serving relay UE may trigger the RRI and release the resources for the link to the remote UE and also corresponding cellular links to the network. Upon receiving RRI, the new serving relay UE may determine not to forward the buffered data to the previous serving relay UE, but to transmit the buffered data via its own cellular connection.

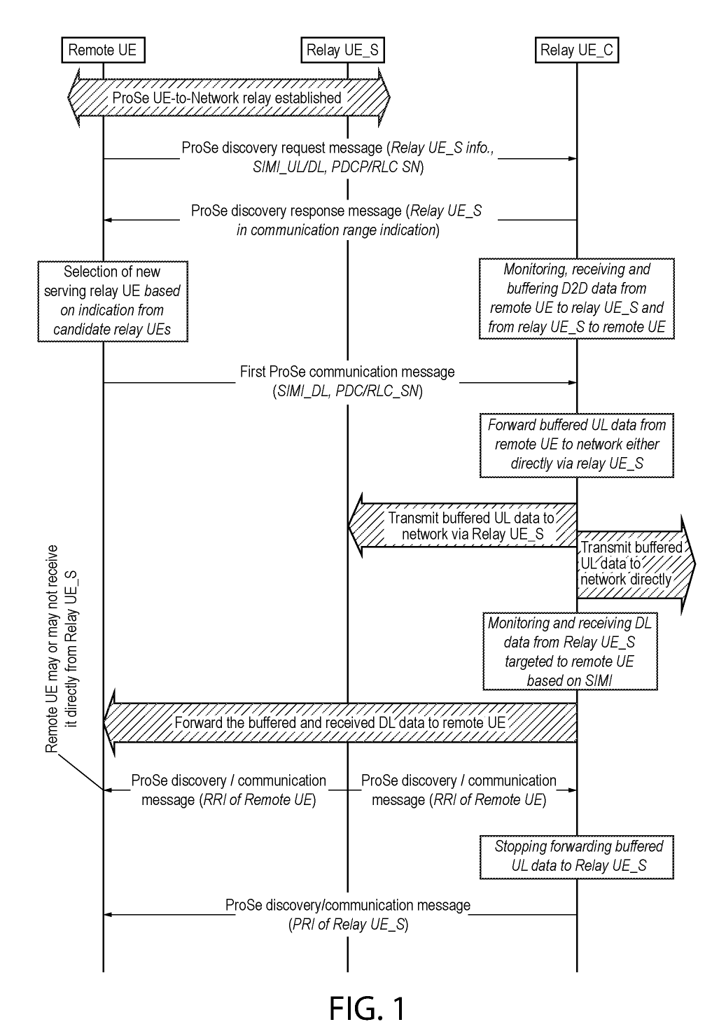

FIG. 1 illustrates an example signaling diagram according to some embodiments of the invention. As illustrated in FIG. 1, Relay UE_S represents the serving relay UE and Relay UE_C represents the candidate relay UE. During relay UE reselection, one of the candidate relay UEs may become a new serving relay UE and then Relay UE_S in FIG. 1 may become a previous serving relay UE. SIMI in FIG. 1 represents service interruption minimization indication from the remote UE to candidate relay UEs. The SIMI may be common for both UL and DL, or may be separately indication for DL and UL traffic. RRI in FIG. 1 represents resource release indication, which is targeted to the remote UE from the serving relay UE either directly or forwarded by the new serving relay UE if the remote UE cannot receive it directly from the previous serving relay UE due to, for example, mobility or direct radio link failure.

Embodiments of the invention provide a solution without the need for assistance from RAN for service interruption minimization during ProSe UE-to-Network Relay reselection. The proposed data forwarding between previous and new serving relay UEs becomes lightweight operation thanks to ProSe UE-to-Network Relay communication based on 3GPP Release 12 1:M communication which does not require explicit communication connection establishment beforehand at least at AS level.

In addition, to provide a possible fullest environment awareness to help remote UEs to make better decision for UE-to-Network Relay operation, certain embodiments can be extended to allow all individual candidate relay UEs (pre-configured and selected by the network) and remote UEs (having active relay or needing a relay connection) to discover and advertise about other relay UEs and remote UEs in its proximity which may include also the serving cell context (serving cell ID) thereof.

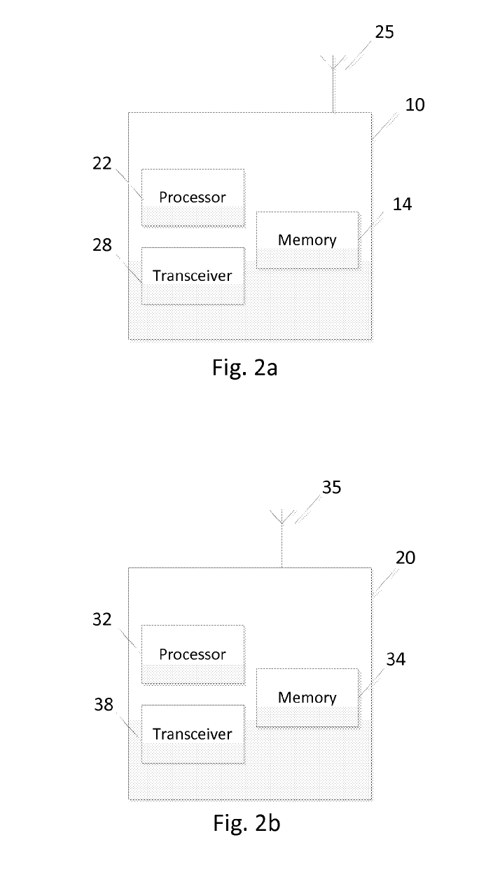

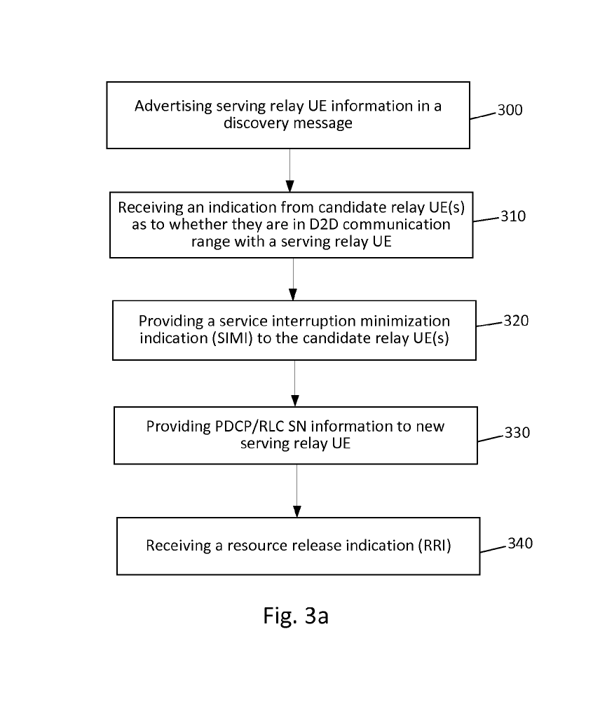

FIG. 2a illustrates an example of an apparatus 10 according to an embodiment. In an embodiment, apparatus 10 may be a node, host, or server in a communications network or serving such a network. For example, in certain embodiments, apparatus 10 may be a remote UE in a D2D based communications system. However, in other embodiments, apparatus 10 may be other components within a radio access network. It should be noted that one of ordinary skill in the art would understand that apparatus 10 may include components or features not shown in FIG. 2a.

As illustrated in FIG. 2a, apparatus 10 includes a processor 22 for processing information and executing instructions or operations. Processor 22 may be any type of general or specific purpose processor. While a single processor 22 is shown in FIG. 2a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 may further include or be coupled to a memory 14 (internal or external), which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 may be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

In some embodiments, apparatus 10 may also include or be coupled to one or more antennas 25 for transmitting and receiving signals and/or data to and from apparatus 10. Apparatus 10 may further include or be coupled to a transceiver 28 configured to transmit and receive information. For instance, transceiver 28 may be configured to modulate information on to a carrier waveform for transmission by the antenna(s) 25 and demodulate information received via the antenna(s) 25 for further processing by other elements of apparatus 10. In other embodiments, transceiver 28 may be capable of transmitting and receiving signals or data directly.

Processor 22 may perform functions associated with the operation of apparatus 10 which may include, for example, precoding of antenna gain/phase parameters, encoding and decoding of individual bits forming a communication message, formatting of information, and overall control of the apparatus 10, including processes related to management of communication resources.

In an embodiment, memory 14 may store software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, in one embodiment, apparatus 10 may be a network node, network entity, or control entity in a communications system, such as a remote UE in a D2D based system. According to an embodiment, apparatus 10 may be controlled by memory 14 and processor 22 to advertise serving relay UE information in a discovery message, and to receive an indication from candidate relay UE(s) as to whether they are in D2D communication range with a current serving relay UE. In an embodiment, the advertising may be performed when apparatus 10 wants to discover relay UEs for relay UE reselection. The discovery message may be a ProSe UE-to-network discovery request message. According to one embodiment, the serving relay UE information may be a ProSe relay UE ID.

In certain embodiments, apparatus 10 may be further controlled by memory 14 and processor 22 to provide a service interruption minimization indication (SIMI) to the candidate relay UE(s) during relay UE discovery or during one-to-one communication between the apparatus 10 and a new serving relay UE. The SIMI may indicate that some or all services of the apparatus 10 need service continuity support. In some embodiments, the SIMI may be provided at the user group, user service, UE or logical channel level and may depend on the user group/service/UE/logical channel QoS or priority. According to one embodiment, apparatus 10 may be further controlled by memory 14 and processor 22 to provide PDCP/RLC SN information to a new serving relay UE in order to assist in packet loss recovery.

In an embodiment, apparatus 10 may be further controlled by memory 14 and processor 22 to receive a resource release indication (RRI) in a ProSe discovery/communication message and, upon receipt of the RRI, to release resources used locally in the apparatus 10.

FIG. 2b illustrates an example of an apparatus 20 according to another embodiment. In an embodiment, apparatus 20 may be a node, host, or server in a communications network or serving such a network. For instance, in some embodiments, apparatus 20 may be a relay UE in a D2D based communications system. It should be noted that one of ordinary skill in the art would understand that apparatus 20 may include components or features not shown in FIG. 2b.

As illustrated in FIG. 2b, apparatus 20 includes a processor 32 for processing information and executing instructions or operations. Processor 32 may be any type of general or specific purpose processor. While a single processor 32 is shown in FIG. 2b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 may further include or be coupled to a memory 34 (internal or external), which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 may be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

In some embodiments, apparatus 20 may also include or be coupled to one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulate information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a UE, such as a relay UE in a D2D based system. In an embodiment, apparatus 20 may correspond to relay UE_C in FIG. 1 discussed above. In this embodiment, apparatus 20 may be controlled by memory 34 and processor 32 to receive serving relay UE information from a remote UE, and to use the serving relay UE information to check if a current serving relay UE is in D2D communication range. Apparatus 20 may then be controlled by memory 34 and processor 32 to provide an indication to the remote UE of whether the current serving relay UE is in D2D communication range to assist in relay UE reselection. In an embodiment, the serving relay UE information may be received in a relay discovery request message.

In certain embodiments, apparatus 20 may also be controlled by memory 34 and processor 32 to receive a SIMI, and optionally a PDCP/RLC SN information, in a relay UE discovery message or the first D2D communication message for one-to-one communication. Upon receiving the SIMI, and optionally a PDCP/RLC SN information, apparatus 20 may be controlled by memory 34 and processor 32 to start monitoring, receiving, buffering, and/or forwarding the D2D communication targeted to the remote UE.

According to some embodiments, apparatus 20 may also be controlled by memory 34 and processor 32 to forward a resource release indication (RRI) in a ProSe discovery/communication message targeted to the remote UE. The remote UE ID may also be indicated with the RRI in the ProSe discovery/communication message. For the DL direction, the

RRI may be received from the previous serving relay UE in which it is triggered by the empty buffer of data targeted to the remote UE and forwarded to the remote UE. For the UL direction, the RRI may be received from the previous serving relay UE in which it is triggered by the inactivity detection and forwarded to the remote UE.

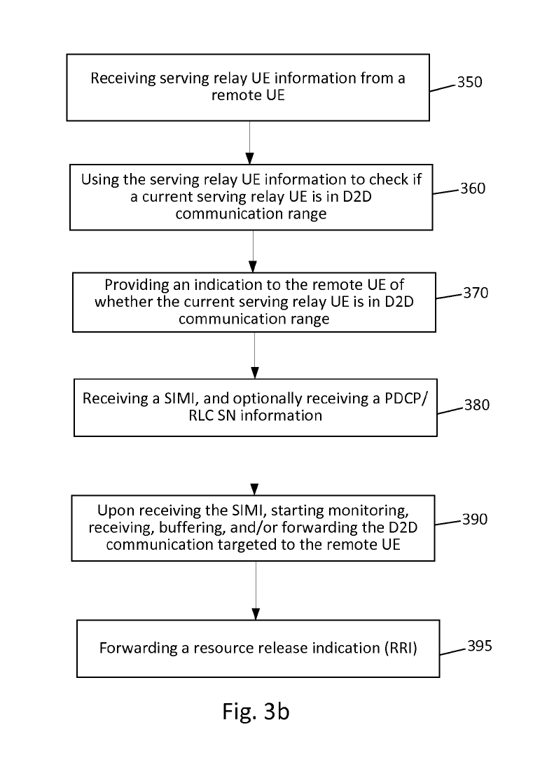

FIG. 3a illustrates an example flow diagram of a method, according to one embodiment of the invention. In one embodiment, the method of FIG. 3a may be performed by a UE, such as a remote UE in a D2D based system. As illustrated in FIG. 3a, the method may include, at 300, advertising serving relay UE information in a discovery message and, at 310, receiving an indication from candidate relay UE(s) as to whether they are in D2D communication range with a serving relay UE, for example, to assist in relay UE reselection.

In an embodiment, the advertising step may be performed when the remote UE wants to discover relay UEs for relay UE reselection. The discovery message may be a ProSe UE-to-network discovery request message, for instance. The serving relay UE information may include a ProSe relay UE ID.

In certain embodiments, the method may also include, at 320, providing a service interruption minimization indication (SIMI) to the candidate relay UE(s) during relay UE discovery or during one-to-one communication between the remote UE and a new serving relay UE. The SIMI may indicate that some or all services of the remote UE need service continuity support. The SIMI may be provided at the user group, user service, UE or logical channel level and may depend on the user group/service/UE/logical channel QoS or priority.

According to some embodiments, the method may include, at 330, providing PDCP/RLC SN information to new serving relay UE in order to assist in packet loss recovery. In an embodiment, the method may further include, at 340, receiving a resource release indication (RRI) in a ProSe discovery/communication message and, upon receipt of the RRI, releasing resources used locally in the remote UE.

FIG. 3b illustrates an example flow diagram of a method, according to one embodiment of the invention. In one embodiment, the method of FIG. 3b may be performed by a UE, such as a relay UE in a D2D based system. As illustrated in FIG. 3b, the method may include, at 350, receiving serving relay UE information from a remote UE and, at 360, using the serving relay UE information to check if a current serving relay UE is in D2D communication range. The method may also include, at 370, providing an indication to the remote UE of whether the current serving relay UE is in D2D communication range to assist in relay UE reselection. In an embodiment, the serving relay UE information may be received in a relay discovery request message.

The method of FIG. 3b may also include, at 380, receiving a SIMI, and optionally a PDCP/RLC SN information, in a relay UE discovery message or the first D2D communication message for one-to-one communication. Upon receiving the SIMI, and optionally a PDCP/RLC SN information, the method may include, at 390, starting monitoring, receiving, buffering, and/or forwarding the D2D communication targeted to the remote UE.

In certain embodiments, the method of FIG. 3b may also include, at 395, forwarding a resource release indication (RRI) in a ProSe discovery/communication message targeted to the remote UE. The remote UE ID may also be indicated with the RRI in the ProSe discovery/communication message, for example. For the DL direction, the RRI may be received from the previous serving relay UE in which it is triggered by the empty buffer of data targeted to the remote UE and forwarded to the remote UE. For the UL direction, RRI may be received from the previous serving relay UE in which it is triggered by the inactivity detection and forwarded to the remote UE.

One embodiment is directed to an apparatus comprising at least one processor, and at least one memory comprising computer program code. The at least one memory and the computer program code are configured, with the at least one processor, to cause the apparatus at least to advertise serving relay UE information in a discovery message, and to receive an indication from candidate relay UE(s) as to whether they are in D2D communication range with a serving relay UE.

Another embodiment is directed to a method which may include advertising serving relay UE information in a discovery message, and receiving an indication from candidate relay UE(s) as to whether they are in D2D communication range with a serving relay UE.

Another embodiment is directed to an apparatus which may include means for advertising serving relay UE information in a discovery message, and means for receiving an indication from candidate relay UE(s) as to whether they are in D2D communication range with a serving relay UE.

Another embodiment is directed to a computer program embodied on a non-transitory computer readable medium. The computer program may be configured to control a processor to perform a process comprising advertising serving relay UE information in a discovery message, and receiving an indication from candidate relay UE(s) as to whether they are in D2D communication range with a serving relay UE.

Another embodiment is directed to an apparatus comprising at least one processor, and at least one memory comprising computer program code. The at least one memory and the computer program code are configured, with the at least one processor, to cause the apparatus at least to receive serving relay UE information from a remote UE, to use the serving relay UE information to check if a current serving relay UE is in D2D communication range, and to provide an indication to the remote UE of whether the current serving relay UE is in D2D communication range to assist in relay UE reselection.

Another embodiment is directed to a method which may include receiving serving relay UE information from a remote UE, using the serving relay UE information to check if a current serving relay UE is in D2D communication range, and providing an indication to the remote UE of whether the current serving relay UE is in D2D communication range to assist in relay UE reselection.

Another embodiment is directed to an apparatus which may include means for receiving serving relay UE information from a remote UE, means for using the serving relay UE information to check if a current serving relay UE is in D2D communication range, and means for providing an indication to the remote UE of whether the current serving relay UE is in D2D communication range to assist in relay UE reselection.

Another embodiment is directed to a computer program embodied on a non-transitory computer readable medium. The computer program may be configured to control a processor to perform a process comprising receiving serving relay UE information from a remote UE, using the serving relay UE information to check if a current serving relay UE is in D2D communication range, and providing an indication to the remote UE of whether the current serving relay UE is in D2D communication range to assist in relay UE reselection.

Embodiments of the invention may provide several advantages and/or technical improvements. For example, embodiments provide a possible fullest environment awareness to help remote UEs to make better decision for UE-to-Network Relay operation. In addition, embodiments can be extended to allow all individual candidate relay UEs (pre-configured and selected by the network) and remote UEs (having active relay or needing a relay connection) to discover and advertise about other relay UEs and remote UEs in its proximity which may include also the serving cell context (serving cell ID) thereof.

According to embodiments, programs, also called program products or computer programs, including software routines, applets and macros, may be stored in any apparatus-readable data storage medium and they include program instructions to perform particular tasks. A computer program product may comprise one or more computer-executable components which, when the program is run, are configured to carry out embodiments. The one or more computer-executable components may be at least one software code or portions of it. Modifications and configurations required for implementing functionality of an embodiment may be performed as routine(s), which may be implemented as added or updated software routine(s). Software routine(s) may be downloaded into the apparatus.

Software or a computer program code or portions of it may be in a source code form, object code form, or in some intermediate form, and it may be stored in some sort of carrier, distribution medium, or computer readable medium, which may be any entity or device capable of carrying the program. Such carriers include a record medium, computer memory, read-only memory, photoelectrical and/or electrical carrier signal, telecommunications signal, and software distribution package, for example. Depending on the processing power needed, the computer program may be executed in a single electronic digital computer or it may be distributed amongst a number of computers. The computer readable medium or computer readable storage medium may be a non-transitory medium.

In other embodiments, the functionality of any method or apparatus described herein may be performed by hardware, for example through the use of an application specific integrated circuit (ASIC), a programmable gate array (PGA), a field programmable gate array (FPGA), or any other combination of hardware and software. In yet another embodiment, the functionality may be implemented as a signal, a non-tangible means that may be carried by an electromagnetic signal downloaded from the Internet or other network.

According to an embodiment, an apparatus, such as a node, device, or a corresponding component, may be configured as a computer or a microprocessor, such as single-chip computer element, or as a chipset, including at least a memory for providing storage capacity used for arithmetic operation and an operation processor for executing the arithmetic operation.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention.

### SUMMARY

In a first aspect thereof the exemplary embodiments of this invention provide a method that comprises advertising current serving relay user equipment information in a discovery message; receiving an indication from at least one candidate relay user equipment as to whether it is in device-to-device communication range with the current serving relay user equipment; and performing a relay user equipment reselection based on the at least one indication to select a new serving relay user equipment.

In a further aspect thereof the exemplary embodiments of this invention provide an apparatus that comprises at least one data processor and at least one memory that includes computer program code. The at least one memory and computer program code are configured, with the at least one data processor, to cause the apparatus, at least to advertise current serving relay user equipment information in a discovery message; receiving an indication from at least one candidate relay user equipment as to whether it is in device-to-device communication range with the current serving relay user equipment; and perform a relay user equipment reselection based on the at least one indication to select a new serving relay user equipment.

In another aspect thereof the exemplary embodiments of this invention provide a method that comprises receiving current serving relay user equipment information in a discovery message from a remote user equipment; using the current serving relay user equipment information to check if the current serving relay user equipment is in device-to-device communication range; and providing an indication to the remote user equipment of whether the current serving relay user equipment is in device-to-device communication range to assist in relay user equipment reselection.

In yet another aspect thereof the exemplary embodiments of this invention provide an apparatus that comprises at least one data processor and at least one memory that includes computer program code. The at least one memory and computer program code are configured, with the at least one data processor, to cause the apparatus to receive current serving relay user equipment information in a discovery message from a remote user equipment; use the current serving relay user equipment information to check if the current serving relay user equipment is in device-to-device communication range; and provide an indication to the remote user equipment of whether the current serving relay user equipment is in device-to-device communication range to assist in relay user equipment reselection.

In yet another aspect thereof the exemplary embodiments of this invention provide an apparatus that comprises means for advertising current serving relay user equipment information in a discovery message; means for receiving an indication from at least one candidate relay user equipment as to whether it is in device-to-device communication range with the current serving relay user equipment; and means for performing a relay user equipment reselection based on the at least one indication to select a new serving relay user equipment.

In yet one further aspect thereof the exemplary embodiments of this invention provide an apparatus that comprises means for receiving current serving relay user equipment information in a discovery message from a remote user equipment; means for using the current serving relay user equipment information to check if the current serving relay user equipment is in device-to-device communication range; and means for providing an indication to the remote user equipment of whether the current serving relay user equipment is in device-to-device communication range to assist in relay user equipment reselection.

1-40. (canceled)

41. A method, comprising:
advertising current serving relay user equipment information in a discovery message;
receiving an indication from at least one candidate relay user equipment as to whether it is in device-to-device communication range with the current serving relay user equipment; and
performing a relay user equipment reselection based on the at least one indication to select a new serving relay user equipment.

42. The method as in claim 41, wherein the discovery message is a proximity services user equipment-to-network relay discovery request message.

43. The method as in claim 41, wherein the advertising further comprising:
providing a service interruption minimization indication to the at least one candidate relay user equipment to indicate at least one service that needs service continuity support.

44. The method as in claim 43, wherein the service interruption minimization indication is provided at one of the user group, user service, user equipment and logical channel level and depending on at least one of the user group, user service, user equipment, logical channel quality of service, and priority.

45. The method as in claim 43 further comprising:
providing at least one of received packet data convergence protocol (PDCP) and radio link control (RLC) sequence number (SN) information in the discovery message or in a one-to-one communication message in order to assist in packet loss recovery.

46. The method as in claim 41, further comprising:
providing a service interruption minimization indication during one-to-one communication with the new serving relay user equipment to indicate at least one service that needs service continuity support.

47. The method as in claim 41, further comprising:
receiving a resource release indication in a proximity services discovery message or in a one-to-one communication message; and
releasing resources used locally for the link with the current serving relay user equipment.

48. An apparatus, comprising:
at least one data processor; and
at least one memory including computer program code, where the at least one memory and computer program code are configured, with the at least one data processor, to cause the apparatus at least to:
advertise current serving relay user equipment information in a discovery message;
receiving an indication from at least one candidate relay user equipment as to whether it is in device-to-device communication range with the current serving relay user equipment; and
perform a relay user equipment reselection based on the at least one indication to select a new serving relay user equipment.

49. The apparatus as in claim 48, wherein the discovery message is a proximity services user equipment-to-network relay discovery request message.

50. The apparatus as in claim 48, wherein the current serving relay user equipment information is a proximity services relay user equipment identity.

51. The apparatus as in claim 48, wherein the at least one memory and computer program instructions configured to advertise current serving relay user equipment information are further configured to, with the at least one processor, cause the apparatus at least to:
provide a service interruption minimization indication to the at least one candidate relay user equipment to indicate at least one service that needs service continuity support.

52. The apparatus as in claim 51, wherein the service interruption minimization indication is provided at one of the user group, user service, user equipment and logical channel level and depending on at least one of the user group, user service, user equipment, logical channel quality of service, and priority.

53. The apparatus as in claim 51, wherein the at least one memory and computer program instructions are further configured to, with the at least one processor, cause the apparatus at least to:
provide at least one of received packet data convergence protocol (PDCP) and radio link control (RLC) sequence number (SN) information in the discovery message or in a one-to-one communication message in order to assist in packet loss recovery.

54. The apparatus as in claim 48, wherein the at least one memory and computer program instructions are further configured to, with the at least one processor, cause the apparatus at least to:
provide a service interruption minimization indication during one-to-one communication with the new serving relay user equipment to indicate at least one service that needs service continuity support.

55. The apparatus as in claim 48, wherein the at least one memory and computer program instructions are further configured to, with the at least one processor, cause the apparatus at least to:
receive a resource release indication in a proximity services discovery message or in a one-to-one communication message; and
release resources used locally for the link with the current serving relay user equipment.

56. An apparatus, comprising:
at least one data processor; and
at least one memory including computer program code, where the at least one memory and computer program code are configured, with the at least one data processor, to cause the apparatus to:
receive current serving relay user equipment information in a discovery message from a remote user equipment;
use the current serving relay user equipment information to check if the current serving relay user equipment is in device-to-device communication range; and
provide an indication to the remote user equipment of whether the current serving relay user equipment is in device-to-device communication range to assist in relay user equipment reselection.

57. The apparatus as in claim 56, wherein the received discovery message is a proximity services user equipment-to-network relay discovery request message.

58. The apparatus as in claim 56, wherein the at least one memory and computer program instructions are further configured to, with the at least one processor, cause the apparatus at least to:
receive a service interruption minimization indication in the discovery message or in a one-to-one communication message to indicate at least one service that needs service continuity support.
perform at least one of monitoring, receiving, buffering, and forwarding device-to-device communication messages targeted to the remote user equipment.

59. The apparatus as in claim 58, wherein the at least one memory and computer program instructions are further configured to, with the at least one processor, cause the apparatus at least to:
receive at least one of a packet data convergence protocol (PDCP) and radio link control (RLC) sequence numbers (SN) information in the discovery message or in the one-to-one communication message.

60. The apparatus as in claim 56, wherein the at least one memory and computer program instructions are further configured to, with the at least one processor, cause the apparatus at least to:
forward a resource release indication in a proximity services discovery message or in a one-to-one communication message to the remote user equipment.
